(19) United States
(12) Patent Application Publication
(10) Pub. No.: US 2007/0288351 A1
(43) Pub. Date: Dec. 13, 2007

(54) Method, system, and computer program for an electronically traded synthetic exchange traded coupon

(76) Inventor: Russell Guy Huntley, North Haledon, NJ (US)

Correspondence Address: Paul E. Schaafsma;NovusIP, LLC, Suite 221, 521 West Superior Street, Chicago, IL, 60610-3135, US

(21) Appl. No.: 11/805,319

(22) Filed: May 22, 2007

Related U.S. Application Data
(60) Provisional application No. 60/747,860, filed on May 22, 2006.

(51) Int. Cl. G06Q 40/00

(52) U.S. Cl. 705/37

(57) ABSTRACT

In accordance with the principles of the present invention, a novel method, system, process, and computer program is provided that synthetically replicates a plain vanilla IR Swap through a future as well as to create a more fungible interest rate swap in the spot market. The forward start interest rate swaps of the present invention consist of a consecutive series of futures that value a forward start interest rate swap to start on a settlement date. The futures replicate the floating-rate payment terms for the interest rate swap that is being synthetically replicated. The spot interest rate swap is a standardized interest rate swap that is fungible.

### RELATED APPLICATION

This application is based upon U.S. Provisional Patent Application No. 60/747,860 titled “Method, System and Computer Program Product for an Electronically Traded Term Structure Futures Contract” filed 22 May 2006.

### FIELD OF THE INVENTION

The present invention relates to a method, a system, computer program, process, and financial instrument for an electronic exchange or broker traded and centrally cleared financial instrument that replicates and creates a synthetic secondary market for interest-rate swaps

### BACKGROUND OF THE INVENTION

An interest-rate swap (IR Swap) is a financial transaction between two counterparties, where one party agrees to exchange fixed-rate interest payments to another party in return for receiving floating-rate payments. The floating-rate payments can be tied to a floating-rate index such as for example the London Inter-Bank Offered Rate (LIBOR). As shown in FIG. 1, the party who makes the fixed interest payments and receives floating-rate payments can be referred to as the payer; the other party who makes variable-rate payments and receives fixed-rate payments can be referred to as the receiver. The interest payments are based on a notional (hypothetical) principal.

The IR Swaps are one of the most frequently used financial derivatives. The Bank of International Settlements, Centralbahnplatz 2, Basel, Switzerland, estimates that there was more than $215 trillion in notional open interest in IR Swaps in 2006. IR Swaps are used by institutional market participants to structure asset and liability positions with regard to the expected and/or implied yield curves, and hedge interest rates by immunizing the duration of their assets and liabilities.

The users of the IR Swap market are, in essence, any organization that is exposed to interest-rate risk. Users can include for example, banks, state treasuries, supranational organizations, insurance companies, investment funds, large corporations, and increasingly small and medium sized corporations. The major participants and liquidity providers in the IR Swap market are global banks which are able to manage interest-rate risk and efficiently administer the vast number of IR Swap transactions.

The IR Swap market arose in the 1980's as companies used IR Swaps to lower their borrowing costs through their comparative advantage in different credit markets. The mechanism of an IR Swap allows each company to exploit their privileged access to one market in order to produce interest-rate savings in a different market. Furthermore, companies needed to ‘lock in’ in longer-term financing rates without actually borrowing longer-term funds. This could be achieved by ‘selling short’ Treasury securities of the appropriate maturity to establish a long-term fixed-payment obligation, and then borrowing the same Treasury securities to facilitate the delivery required by the (short) sale. The risk to the short seller is that, from time to time the specific Treasury security could become ‘special’ (where demand for the securities is very strong but the supply is restricted). A ‘special’ results in interest rates (repo rate) declining, sometimes to zero or even negative. The short seller is still paying the same fixed rate on the Treasuries she has borrowed, but she is now receiving less on her cash collateral even though interest rates have not changed. This risk of specials opened the door for IR Swaps. IR Swaps do not have ‘special’ characteristics.

The IR Swap allows parties to convert all or part of their floating-rate exposure into a fixed-rate exposure and vice-versa. The IR Swap is an efficient method to transform the nature of assets and liabilities. The same result could be achieved by buying one type of bond (fixed/floating) and selling another (floating/fixed). However, an IR Swap is less expensive (issuing debt can be expensive because of the rights of underwriting and legal issues); an IR Swap has less credit risk (an IR Swap is executory meaning that one need perform only if a counterparty performs, whereas a default on a bond would not entail that offset); and an IR Swap is an off-balance sheet instrument (which results in no change in debt-equity ratios, whereas the issuance of a bond raises leverage ratios even if the bond that is issued merely finances the purchase of an equally-valued bond).

An IR Swap can be viewed as two separate bonds—a fixed-rate bond financed with floating-rate debt (long bonds and short floater) and a floater (floating-rate bond) financed with fixed-rate debt (long floater and short bond). The IR Swap effectively allows for the construction of two cash-flow streams with the same maturity. There is no need to put up cash, and the IR Swap allows a party to ‘lock in’ current long-term borrowing costs.

IR Swaps are traded in a primary market. There is a secondary market but it has limitations. The only true secondary market that exists is between dealers who have a warehouse of IR Swaps. The credit rating of the major dealers is almost identical and so they are comfortable trading amongst themselves. But even this secondary market is generally limited to newly executed IR Swaps (e.g., up to three months from issuance).

There are a number of reasons for the lack of a secondary market. The bilateral nature of the IR Swap and its pricing mechanism are inconsistent with a secondary market. To limit counter-party credit risk, a party to an IR Swap would generally not allow a counterparty to sell their position without their consent, as that party may not want to do business with the proposed buyer. But even when an assignment is allowed, the selling of an IR Swap position is not easy. This is because the IR Swap will, more likely than not, be trading off-market (non par).

To understand the off-market (non par) nature of IR Swaps, one needs to understand how IR Swaps are valued. Valuing an IR Swap requires determining the fixed rate (essentially the internal rate of return) for the IR Swap. This requires determining the present value of the floating rate which over time is stochastic. However, at any given time it is possible to create a yield curve reflective of future expectations. Data is obtained from the government yield curve (risk free investment curve) and the swap curve (an AA credit curve). These curves provide expected yields into the future based on the implied expectation of interest rates. From the curve, a spot curve (zero-coupon curve) can be created and from this spot curve a discount factor can be derived for the implied forward floating rates.

This ‘stripping’ of the curve and the successive calculation of discount factors (using the methods described below) can be termed bootstrapping. Bootstrapping is any combination of additive cash flows that can be shown to be a combination of zero coupon cash flows. Splitting an instrument into its constituent zero coupon cash flows is important because an instrument with multiple cash flows should not be discounted using the same interest rate from settlement date to maturity. Intermediate points on the curve can be estimated by assuming a shape for the curve either in discount factor or rate space. Linear, exponential, and cubic splining are different interpolation methods that will give different curve shapes between known points.

The final step is to determine the ‘fair’ value of the IR Swap. The fair value is the fixed rate that equates, on a present value basis, the series of fixed payments to the series of floating-rate payments through the life of the IR Swap. So, the price of the swap when it is created is zero, because the present value of the future fixed rate and expected future floating-rate payments cancel each other out.

When the term structure of interest rates is upward sloping (i.e., short-term rates are lower than intermediate and long-term rates), the fixed rate on an IR Swap is higher than the initial value of the floating index. The upward sloping term structure reflects an implicit forecast that short-term interest rates will rise in the future. During the first half of the tenor for the IR Swaps, the floating-rate payments will be less than that for the fixed rates. In the second half the tenor for the IR Swap the floating rates will be more.

When analyzed from the cash flows on payment dates, with an upward sloping swap curve, the receiver (payer) will have a positive (negative) cash flow in the first half of the tenor of the IR Swap and a negative (positive) cash flow in the second half of the tenor of the IR Swap. This can be seen in FIG. 2. Thus, even if implied forward interest rates do not change, the IR Swap will still become off-market after the first reset of the floating rate as the IR Swap will have less time to maturity and the coupon (swap) rate for the IR Swap will not have changed

For example, assume that the swap rate for a 10-year IR Swap is 5 percent and the swap rate for a 9 year IR Swap is 4.8 percent. The parties enter into a 10-year IR Swap with a fixed rate at 5 percent. One year later, assuming that the implied forward interest rates move in accordance with implied swap curve at the time of entering into the IR Swap, the IR Swap will be off-market.

The reason is that the IR Swap is now a 9 year Swap; however, the IR Swap still has a 5 percent coupon. Payments have been made during the year. But now if the payer wanted to exit his position, he would be exiting from an out-the-money (off-market) position. A party looking to take the payer's position in the IR Swap would not be interested in taking the position unless that party was going to get paid a premium to take the position. Why would a buyer agree to make a 5 percent fixed payment for the remaining 9 years, when he could go into the market and enter an IR Swap with someone else and only has to pay 4.8 percent? On the other hand, if the receiver wanted to exit his position, he would want to be compensated for his in-the-money (also an off-market) position. The receiver knows that there is value to a buyer who can receive 5 percent fixed for the next 9 years when the market is only providing a 4.8 percent fixed.

However, if the parties acquired their positions in the IR Swap at-market and held it to its term, and the interest rates moved in accordance with the swap curve at the time the IR Swap was entered into, neither party will be out-the-money.

An off-market (non par) IR Swap can be sold, but generally pricing becomes an issue. The party wanting to exit their position could enter into a new IR Swap with another party to offset the existing IR Swap at a better price. A major drawback of having to enter into a new IR Swap to offset an existing IR Swap is that it does not eliminate the existing IR Swap. There are now two IR Swaps that offset one another and are thus hedged; however, there are now two IR Swaps that have to be managed (credit, daily mark-to-market (MTM), and collateral management), which adds to the cost of the position. The need for having to enter into a new IR Swap to offset an existing IR Swap is one of the reasons why the open interest in IR Swaps is so large and keeps growing.

Interest-rate sensitivity can be measured by duration, modified duration, and convexity. Duration is a measurement of how long (in years) it takes for the price of a bond to be repaid by its internal cash flows. Duration is an important measure for investors to consider, as bonds with higher durations carry more risk and have higher price volatility than bonds with lower durations. Modified duration shows how much the duration changes for each percentage change in yield. Modified duration shows the sensitivity of a one percentage move in interest rates.

Duration is a linear measure of how the price of a bond changes in response to interest rate changes. As interest rates change, the price is not likely to change linearly, but instead the price would change over some curved function of interest rates. The more curved the price function of the bond is, the more inaccurate duration is as a measure of the interest-rate sensitivity. Convexity is a measure of the curvature of how the price of a bond changes as the interest rate changes; that is, how the duration of a bond changes as interest rates changes. Specifically, duration can be formulated as the first derivative of the price function of the bond with respect to the interest rate in question. Then the convexity would be the second derivative of the price function with respect to the interest rate.

Duration, modified duration, and convexity of an IR Swap are easily approximated as a fixed-rate bond with a similar coupon rate, payment frequency, and maturity date. Receiving the fixed rate in a swap increases a bond portfolio's duration and improves convexity, while paying the fixed rate will shorten a portfolio's duration and decrease convexity. The lack of a secondary market for IR Swaps restricts hedging choice with regards to interest-rate sensitivity. Users of IR Swaps are currently limited to the duration and convexity of the at-market (par) IR Swaps, which is where the liquidity lies.

Interest-rate swaptions (“Swaption”) are options (a right and not an obligation) to enter into an IR Swap agreement on pre-set terms. The underlying instrument for a Swaption is a forward start IR Swap, that is, an IR Swap that starts at an agreed date in the future. For example the Swaption could be a 3*43, which would be an option to enter into an IR Swap in 3-months and end 10 years later (43 months). The purchaser and seller of the Swaption agree on the expiration date, option type (e.g., Payer's Swaption), exercise style (e.g., European, Bermudan), the terms of the underlying swap and the type of settlement (e.g., cash or swap).

As the expiration date approaches, the Swaption holder can either notify the seller of the holder's intention to exercise or let the option expire. The terminology used in describing and analyzing Swaptions, like the name Swaption itself, combines the terminology of swaps and options. Like IR Swaps, Swaptions are easier to understand and the relationships are easier to remember if everything is viewed from the fixed-rate side rather than the floating-rate (money market) side of the underlying swap transaction.

A payer's Swaption (“Payer's Swaption”) is the right to pay a fixed rate. A Payer's Swaption is similar to a put on a fixed-rate instrument (the fixed-rate side of the IR Swap). The most common objective in buying a Payer's Swaption is to obtain protection from having to pay a substantially higher fixed rate over the life of a projected IR Swap. Because the swap rate is a specific rate, a Swaption provides highly specific interest rate risk protection. If interest rates rise over the life of the Payer's Swaption, the holder of the Swaption will exercise the right to pay the pre-set fixed rate (now lower than the market rate). The seller of the Payer's Swaption will receive a lower fixed rate on the IR Swap than the seller would have received if the terms had been set at market rates on the start date of the IR Swap, but the Swaption premium will increase his effective fixed rate. If interest rates fall, the value of the fixed-rate payments will fall and the Payer's Swaption will not be worth exercising. The Swaption buyer will pay a higher effective rate than the market rate in effect on the exercise date as he amortizes the Swaption premium and adds it to the market rate. The seller of a Swaption can view the premium as increasing the effective rate he receives in the swap with the caveat that, like any option seller, he may be incurring an opportunity loss if the Swaption is exercised.

A receiver's Swaption (“Receiver's Swaption”) is the right to receive a fixed rate. A Receiver's Swaption is similar to a call on a fixed-rate instrument (the fixed-rate side of the IR Swap). The most common objective in buying a Receiver's Swaption is to speculate on the decline in interest rates. If interest rates decline over the life of the Receiver's Swaption, the holder of the Swaption will exercise the right to receive the pre-set fixed rate (now higher than the market rate). The seller of the Receiver's Swaption will pay a higher fixed rate on the IR Swap than it would have paid if the terms had been set at market rates on the start date of the IR Swap, but the Swaption premium will decrease his effective fixed rate. If interest rates rise, the value of the receipt of the fixed-rate payments will fall and the Receiver's Swaption will not be worth exercising. Swaptions can be applied in a variety of ways for both active traders as well as for corporate treasurers. Dealers can use them for speculation purposes or to hedge a portion of their swap books. The attraction of Swaptions for corporate treasurers is that the forward element in all Swaptions provides the attractions of the forward start IR Swap and to the owner of the put or call, the flexibility to exercise or not, as may be considered appropriate.

The buyer of a Payer/Receiver Swaption pays a premium for the right but not the obligation to pay/receive the fixed rate and receive/pay the floating rate of interest on a forward start IR Swap. The Swaption premium is expressed as basis points. These basis points are applied to the nominal principal of the forward start IR Swap. A borrower using a Swaption would amortize the premium over the life of the option if the Swaption is entered into for the reasons of hedging an underlying borrowing. Swaptions can be cash settled; therefore at expiry Swaptions are settled to market at the applicable forward curve at that time and the difference is settled in cash. Marking-to-market of a Swaption depends on the strike rate of the swap and the relationship of the strike price to the underlying, where the underlying is the forward start IR Swap.

The pricing methodology for a Swaption involves setting up a model of the probability distribution of the forward zero-coupon curve at the time of pricing and imposing that model on the forward start IR Swap's cash flow structure, with the aim of obtaining a probability distribution of the net present value of the cash flows. The zero-coupon curve is assumed to undergo a Markov process (which is a distinct class of stochastic process). A stochastic process literally means ‘guessable’ and can be described as a process which involves a random variable in which the successive values are inter-dependent in some way. The probability distribution of the forward curve depends, amongst other factors, on the Swaption maturity (time to expiration), the appropriate interest rate for that period, the current forward curve, and the implied volatility (the assumed rate of change of the curve). Payer' Swaption will increase with an upward shift in the swap curve; for example, a 1-year×5-year European Payer' Swaption has a strike price at 6 percent. On expiration date if the swap rate is greater than 6 percent, the buyer will exercise the Payer' Swaption; if the swap rate is less than 6 percent, the buyer will let it lapse.

Swaptions are useful for example to those businesses tendering for contracts. Businesses need to settle the question whether to commit to borrowings in the future in their own currency in terms of a tender on a future project. A business would find it useful to bid on a project with full knowledge of the borrowing rate should the contract be won.

IR Swaps and Swaptions are derivatives. Federal Accounting Standard (FAS) No. 133 promulgated by the Financial Accounting Standards Board, 401 Merritt 7, P.O. Box 5116, Norwalk, Conn. 06856 states that the only way to account for derivatives is by the derivative's fair value and that fair value has to be determined at least quarterly. Thus changes in implied forward rates can impact earnings. FAS 133 provides for two hedging methods to avoid an impact on earnings: a fair value hedge, where a derivative is used to hedge the fair value of a financial asset or liability, and a cash flow hedge.

A fair value hedge will result in a change in the value of the hedged financial asset (liability) being recognized in earnings, and the changes in value of the IR Swap being recognized in current earnings. The combination of the change in the value of the IR Swap and the change in value financial asset (liability) are offset in earnings. In a cash flow hedge changes in the value of a swap are recognized first in the statement of comprehensive income. Comprehensive income is the sum of net income and other items that must bypass the income statement because they have not been realized. Comprehensive income is recorded under the accumulated other comprehensive income section of shareholders equity. Comprehensive income is subsequently recognized in earnings as interest payments on the underlying hedged asset (liability). At maturity, the IR Swap's value reduces to zero. The IR Swap's carrying value is adjusted each period to reflect actual swap payments or receipts. The change in the financial asset (liability) is recognized in earnings as incurred. The combination of change in the value of an IR Swap and financial asset (liability) is offset in earnings.

A crucial aspect of being able to treat a derivative as a hedge is that it has to be an effective hedge. An effective hedge is governed by the 80/120 rule. Under this standard, hedges qualify for hedge accounting treatment only if the results from the hedge are expected to correspond to no less than 80 percent change and no more than 120 percent of the of the associated change in the item being hedged.

Despite the enormous size of the IR Swap market, barriers to entry exist for new, and sometimes existing, participants. This is due to the fact that the IR Swap marketplace is based on bilateral agreements rather than on a tradable and securitized asset. As a result, complex customized legal documents need to be executed between the parties, which cost time and money. This has changed somewhat as the International Swap Dealers Association (ISDA) 360 Madison Avenue, 16th Floor, New York, N.Y. 10017 has developed the commoditized ISDA Master Agreement. However, the ISDA Master Agreement has its own issues. There are a number of legal issues in the agreement that have not yet been tested in a court of law. It would also be beneficial for participants to freely net positions across multiple counterparties so as to reduce credit exposure and allow for the freeing up of capital. Bilateral netting arrangements facilitate netting of positions between specific counterparties, but are not available to everyone.

Since the IR Swap is a bilateral agreement, participants have counter party credit risk. The IR Swap is only as good as the credit rating of the counterparty to the IR Swap. Counterparties with weaker credit ratings (e.g., weaker than the AA credit rating of Benchmark Swap Curve) traditionally had to pay a credit premium—the swap rate being greater than a benchmark swap rate for example the ISDA Benchmark Swap Rate. This has changed as the banks have established collateral functions amongst themselves, where today it is estimated that approximately 80 percent of IR Swaps are covered by collateral. Cash is most frequently used as collateral; however, managing collateral costs time and money.

One barrier to entry is due to a heavy concentration of business among a handful of the largest global banks. As bid and ask spreads have narrowed, many smaller dealers have reduced market participation or left the market. In 2003 six banks in the United States had approximately 56 percent of market share. This heavy concentration has raised the issue of systematic risk within in the Bank of International Settlements. One concern is what would happen if one of these large banks ran into difficulty.

IR Swaps have traditionally been traded in the over-the-counter (OTC) market where transactions have traditionally been negotiated over the telephone. This process is an inefficient means to transact business. Users of IR Swaps can decide on how often to mark-to-market (MTM) their open IR Swap positions. As there is no centralized clearing, marking-to-market is generally not done only a daily basis. What would therefore be beneficial in addressing these issues would be a novel standardized IR Swap that can be electronically (exchange) traded with a centralized clearing agent that manages risk on a margin basis.

A number of electronic platforms (e-platforms) have been created in attempting to trade IR Swaps. In 2000, Blackbird (112 South Tryon Street, 18th Floor, Charlotte, N.C. 28284) was one of the first e-platforms. In 2003, dealers starting using bilateral dealer-to-client electronic trading platforms. In 2005, Thomson's TradeWeb (Harborside Financial Center, 2200 Plaza Five, Jersey City, N.J. 07311) and Bloomberg's SwapTrader (499 Park Avenue, New York, N.Y. 10022) brought multilateral dealer-to-client swap trading platforms. Dealer banks typically stream swap prices to a subset of these platforms, while attempting to control the precise size and level offered according to the platform and client type. It is estimated that approximately 10 percent of IR Swaps are now traded electronically; however, these electronic trading platforms do not have centralized clearing, although SwapClear (Aldgate House, 33 Aldgate High Street, London EC3N 1EA) has been acting as a centralized clearing agent for IR Swaps in the Europe since 2000.

A number of futures exchange have standardized an IR Swap so that it can be electronically traded and as well as be centrally cleared. They are the Chicago Board of Trade (141 West Jackson Blvd., Chicago, Ill. 60604), The Chicago Mercantile Exchange (CME) (20 South Wacker Drive, Chicago, Ill. 60606), and the London International Financial Futures and Options Exchange (LIFFE) (Cannon Bridge House, 1 Cousin Lane, London EC4R 3XX). The exchanges provide price transparency and the futures can be used to hedge or speculate on interest rates; however, the futures cannot be used to synthetically replicate an IR Swap. First, the swaps listed on the exchanges are constant maturity swaps. The swaps are always valuing a forward start IR Swap (traditionally a 5 year or a 10 year IR Swap). The only futures that come close to being able to replicate an IR Swap are those that track floating-rate instruments, such as the CME Eurodollar futures for LIBOR. The swap rate (coupon) for an IR Swap is determined from the present value of the floating-rate cash flows. Thus, a strip of Eurodollar futures can be bought or sold. A strip is simply the coordinated purchase or sale of a series of futures with successive expiration dates.

By using a strip, a market participant can lock-up a yield for a period of time equal to the length of the strip. For example, a Eurodollar strip consisting of futures with 40 successive expirations would lock up a 10-year term rate; 20 successive futures would fix a 5-year rate; and 8 successive futures would fix a 2-year rate, and so on. But buying multiple Eurodollar futures takes time and effort. Furthermore, like ordinary coupon bearing bonds IR Swaps have positive convexity, while the Eurodollar futures have no convexity. The Eurodollar futures essentially have linear duration. If the Eurodollar future is used as a hedge it would exhibit negative convexity, while the IR Swap would exhibit no convexity. Thus, if the IR Swap was valued using Eurodollar futures and there was no adjustment for the convexity bias, there would be a mis-pricing in the IR Swap. Even though this convexity bias can be overcome by using alternative interest-rate term-structure models to estimate the convexity adjustment, the models are not easy to use and working with a strip of Eurodollar futures is more of an art than a science.

### SUMMARY OF THE INVENTION

In accordance with the principles of the present invention, a novel method, system, process, and computer program is provided that synthetically replicates a plain vanilla IR Swap through a future as well as to create a more fungible interest rate swap in the spot market. For ease of description herein, the future is non-limitingly referred to herein as a “forward start interest rate swap” and the more fungible interest rate swap is referred to as “spot interest rate swap”. Together they are referred to as “interest rate swaps of the present invention”. The forward start interest rate swaps of the present invention consist of a consecutive series of futures that value a forward start interest rate swap to start on a settlement date. The futures replicate the floating-rate payment terms for the interest rate swap that is being synthetically replicated. The spot interest rate swap is a standardized interest rate swap that is fungible.

In one embodiment, the interest rate swaps of the present invention are exchange (electronically) traded and cleared through a centralized clearing agent. The interest rate swap will track an IR Swap that conforms to the terms prescribed by the ISDA in each market (currency) for the purposes of computing the daily fixing such as payment frequency and day count.

The present invention will provide many benefits. The present invention will establish a secondary market for IR Swaps and provide users with an easier means to exit an IR Swap position. The present invention would reduce costs and the need to manage multiple IR Swap positions resulting from IR Swap offsets. With the present invention, a liquid secondary market for off-market IR Swaps would result in IR Swap positions being netted. As a result, there would not be IR Swap positions left to manage. This is seen as in contrast to managing two IR Swaps after entering into a new IR Swap to offset an existing IR Swap. The present invention would also result in reduction of open interest in IR Swaps, which will reduce overall systematic risk.

Due to the secondary market, the present invention would provide users of IR Swaps with more choice with regards to duration, modified duration, and convexity.

The present invention would address the need for a bilateral swap agreement (e.g., the ISDA Master Agreement). The interest rate swaps of the present invention would be traded according to the rules established by the clearing agent. The present invention would also address the need for bilateral collateral and netting agreements (arrangements). The clearing agent can automatically net trades on a daily basis and the interest rate swaps would be MTM daily. If there is a large movement in price, the clearing agent can make a margin call to the trader. Elimination of the ISDA Master Agreement would save time and money, and lower legal fees.

The present invention would move the IR Swap market from a ‘negotiated’ semi-transparent market to a more transparent auction market for the best price. This would minimize bid-offer spreads and lower transaction costs. There the need to track paper flow to confirm trade that was made over the telephone could be reduced or eliminated. The present invention would also reduce credit risk. Users would have exposure to the strong counterparty credit of a clearing agent.

The present invention would provide users with an easier means to track profit and loss with daily MTM. This would assist parties that utilize value-at-risk analysis for their portfolios. The present invention would also assist parties in complying with FAS 133. Fair value for the interest rate swap of the present invention can be determined more frequently (e.g., daily).

The present invention would significantly lower administrative costs. The present invention would address the administrative costs (and liabilities) associated with maintaining IR Swap cash flows, managing credit oversight, managing collateral, making daily mark-to-market, collecting financial data, record-keeping, and overseeing personnel implementing these functions.

The forward start interest rate swap of the present invention will not only allow for the synthetic replication of an IR Swap, it would also create an efficient means to hedge IR Swap positions as well as support trading in IR Swap futures, Treasury futures, and Eurodollar futures. These can all be used to hedge interest-rate risk.

The present invention would further standardize the IR Swap, which in turn will make it easier for swap users to trade swap curve exposure, and to evaluate the relative utility and effectiveness of alternative positions and strategies. The present invention would improve overall capital efficiency; the clearing service provider's clearing guarantee reduces the need for users to hold large amounts of capital against the risk of market downturns. The present invention would allow banks, corporations, and portfolio managers to substitute inexpensive risk management for expensive capital.

The present invention would allow investment managers to achieve the economic goal of putting their capital to the most efficient possible use. The present invention would provide corporate issuers with a means to hedge adverse market conditions during the period leading up to issuance. The present invention would enable corporate bond holders and money managers to hedge against market downturns, manage duration exposure, and securitize cash. The present invention would enable mortgage securities holders and insurance companies to manage duration gap exposure. The present invention would provide proprietary traders with a means to trade generic swap-rate exposure against their cash market holdings. The present invention would provide hedge fund traders with a cost-effective means to create swap-rate exposure without the administrative costs of the IR Swap alternatives. The present invention would provide the benefits of the IR Swap Market to many more users.

The present invention would increase the use of IR Swaps across a broader base. The present invention would open trading of the swap curve for yield curve traders.

### BRIEF DESCRIPTION OF THE DRAWINGS

FIG. 1 is a schematic illustration of an interest rate swap.

FIG. 2 is a schematic illustration showing the net present value of an interest rate swap at initiation and payments over time with an upward sloping yield curve.

FIG. 3 is a schematic illustration showing the operational dynamics of a market for interest rate swaps in accordance with the principles of the present invention.

FIG. 4 is a schematic illustration for a forward start interest rate swap.

FIG. 5 is a schematic illustration showing the differences between a forward start interest rate swap of the present invention and a forward start swap.

FIG. 6 is a schematic illustration showing the mechanics of a 2-year forward start interest rate swap of the present invention.

FIG. 7 is a schematic illustration showing the affect changes in interest rates will have on a forward start interest rate swap of the present invention.

FIG. 8 shows how changes in interest rates affect the forward start interest rate swap of the present invention.

FIG. 9 shows a sampling of the forward start interest rate swap array curve matrix in accordance with the principles of the present invention.

FIG. 10 is a flowchart that shows daily process for each forward start interest rate swap of the swap array curve matrix of the present invention.

FIG. 11 is a flowchart that shows the daily process for a forward start interest rate swap option in accordance with the principles of the present invention.

FIG. 12 is a screen shot of an application program interface in accordance with the principles of the present invention.

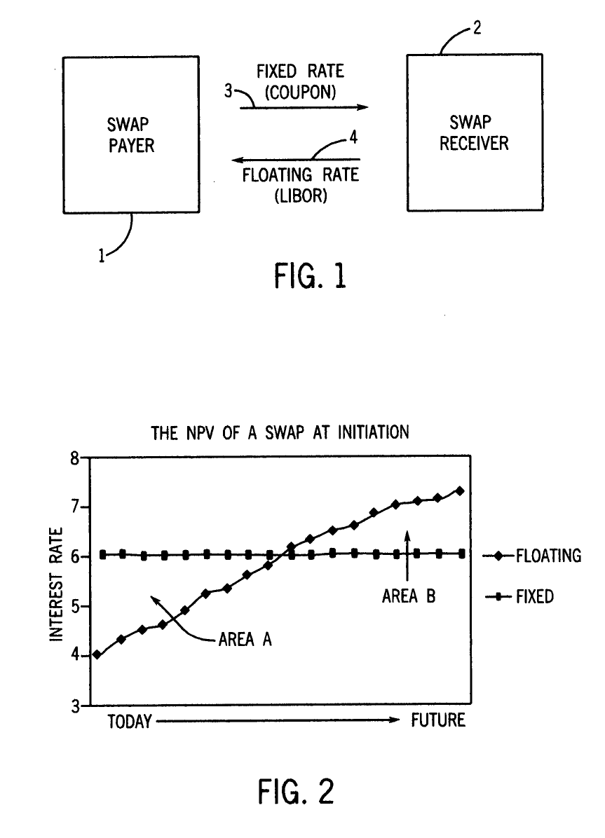

### DETAILED DESCRIPTION OF THE INVENTION

The invention itself, together with further objects and attendant advantages, will be understood by reference to the following description, taken in conjunction with the accompanying drawings. As those skilled in the art will appreciate, the system described herein should accommodate a plurality of financial markets.

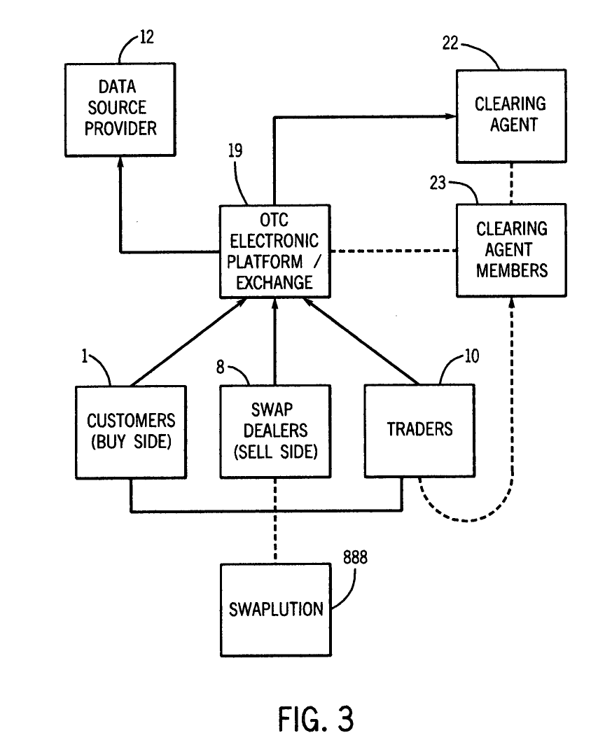

Referring first to FIG. 3, a schematic illustration is seen showing the operational dynamics of a market for interest rate swaps in accordance with the principles of the present invention. The market can be comprised of an electronic over-the-counter (OTC) (or exchange) based trading system. An OTC electronic platform (or futures exchange) 19 is a forum through which dealers 8, customers 1, and traders 10 can trade. A futures exchange can be used if the interest rate swap of the present invention is traded by retail clients. Otherwise an OTC e-platform can be used. The OTC e-platform (or futures exchange) 19 can incorporate any variety of rules, conventions, and facilities for trading between the dealers 8, customers 1, and traders 10, and allow for anonymous trading. The transactions can be cleared through an independent futures clearing agent 22. The futures clearing agent 22 can clear and net the trades of the interest rate swaps of the present invention and can become the counterparty to interest rate swaps traded on the exchange, thus, guaranteeing the financial integrity of the dealers 8, customers 1, and traders 10. Clearing agents 22 can protect themselves and other participants from credit default by the margining of dealers 8, customers 1, and traders 10, and pricing positions daily on a MTM basis. The clearing agent 22 may require that each customer 1 be approved by the clearing agent 22 to become counterparty to the clearing agent 22; otherwise, customers will have to conduct their transactions through a clearing agent member 23. A data provider 12 can provide swap-rate data (e.g., the Benchmark Swap Curve) to the electronic platform/exchange 19, which can use the data to settle start interest rate swaps. The dealers 8, customers 1, and traders 10 can use the application program interface of the present invention (as described below), an application specifically designed for this invention to provide information on the listed interest rate swaps.

The OTC e-platform (futures exchange) 19 can incorporates a screen-based (i.e., computerized) trading system. The present invention is easily adapted to virtually any conceivable electronic trading system. Communications links between participants can be established over a network of computers linked by telephone lines or high bandwidth telecommunications links, although some of the interconnections can be established by voice over a telephone network. Computer networks over which the present invention can be implemented can include local area networks and wide area networks, including the Internet. Computer network systems such as for example those provided by Information Service Providers (ISVs), such as Bloomberg Financial, 731 Lexington Avenue, New York, N.Y. 10022; Trading Technologies, 222 South Riverside Plaza, Suite 1100, Chicago, Ill. 60606; TradeWeb; and Reuter's, The Reuters Building, South Colonnade, Canary Wharf, London, E14 5EP, United Kingdom can be easily adapted to provide pricing vendors and/or to disseminate forward start interest rate swap price and trading execution. Accordingly, buyers and sellers can send and receive trade data and other information (including, for example, prices, bids, quotes, and information relating to specific forward start interest rate swaps) at remote locations.

As known in the art, the methods and processes in accordance with the principles of the present invention can be embodied as computer readable codes fixed in a tangible medium. The computer codes used for the methods and processes of the present invention can be any interpreted or executable code mechanism, including but not limited to scripts, interpreters, dynamic link libraries, and complete executable programs which when executed perform methods and processes in accordance with the principles of the present invention.

A forward start interest rate swap in accordance with the principles of the present invention is comprised of a consecutive series of futures that value a forward start IR Swap to start on the upcoming International Monetary Market (IMM) settlement date promulgated by the CME. The IMM settlement dates are the third Wednesday of March (H), June (M), September (U), and December (Z). The term of the futures replicate the floating-rate payment terms for the IR Swap that is being synthetically replicated.

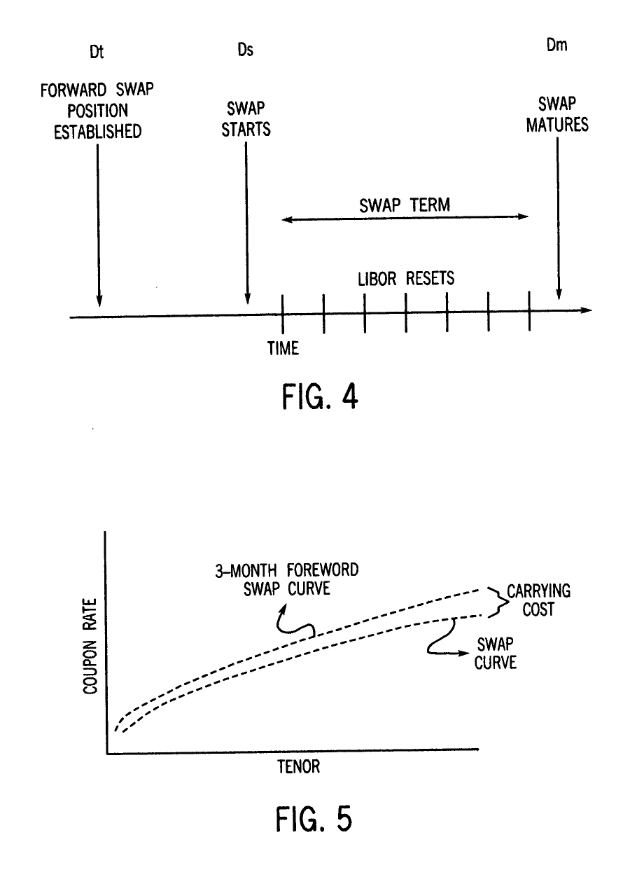

FIG. 4 shows a schematic diagram of a forward start IR Swap. A forward start swap is an IR Swap that starts at a future date. On date Dt the parties enter a forward start IR swap to start on date Ds and expiring on a maturity date Dm. As seen in FIG. 4, the price for the forward start IR Swap will be different from the spot price for the IR Swap. The greater price in forward pricing is due to an investor having to bear economic risk on a slightly longer instrument (the time to when the IR Swap starts) and not receiving the positive carry of the coupon until the start date of the future. For a 3-month forward 10-year forward start swap, the forward pricing is reflecting a receiver losing carry equal to difference between the rate on a 10-year-and-3-month swap and a 10-year swap. The price will also reflect the carry cost which will be the 3-month floating rate. The forward pricing is available from data providers.

Each forward start interest rate swap of the present invention can be defined by its maturity date and its coupon. When it is traded, the parties are synthetically taking a position in a forward start IR Swap with a similar maturity date and coupon that will start on the upcoming IMM Settlement Date. Each forward start interest rate swap will track the present value of the notional principal amount and the notional coupons for a specified maturity date for the IMM Settlement date. For example, if today is Sep. 30, 2007, a forward start interest rate swap of the present invention with a 5.25 percent coupon and a maturity date of December 2017, will be pricing a forward-start 10-year IR Swap to begin on the next IMM Settlement Date, which will be in December (Z) 2007. This forward start interest rate swap in accordance with the principles could be listed as H2007 5.25% Z2017 (or by showing the appropriate IMM Settlement dates). Thus, on the day after the December IMM Settlement Date, the forward start interest rate swap of the present invention will now be pricing a forward-start 9-year-and-9-month IR Swap with a 5.25 percent coupon to begin on the next IMM Settlement Date, which will be in March (H) 2008.

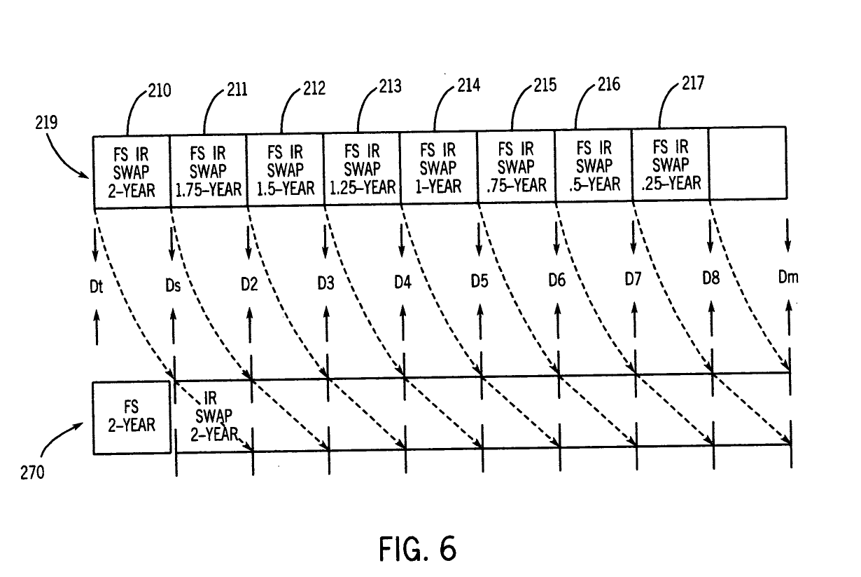

Parties taking a position in a forward start interest rate swap of the present invention will be legally obligated to their position till the maturity date of the forward start interest rate swap, unless the party takes action and exits their position. If they don't exit their position, which they can do at any time, the party will passively hold that position in the forward start interest rate swap until it expires, which will be three months from the maturity date. FIG. 6 shows how the forward start interest rate swap of the present invention differs from a forward start IR Swap. In particular, FIG. 6 shows a forward start 2 year IR Swap 270 and a forward start interest rate swap of the present invention 219 that is a tracking a forward start 2 year IR Swap. The forward start interest rate swap 219 is pricing a forward start IR Swap. The forward start interest rate swap 219 prices a consecutive series of forward start swaps to start on dates Ds, D2, D3, D4, D5, D6, D7, and D8. In contrast, a forward start IR Swap 270 is only pricing a forward start swap from date Dt to Ds, and on date Ds the IR Swap 270 starts. Thereafter, the IR Swap 270 just prices the net present value of an IR Swap for that coupon and maturity date. Once the IR Swap 270 starts on date Ds, the floating rate is reset on dates Ds, D2, D3, D4, D5, D6, D7, and D8, but payments are made 3 months in arrears on dates D2, D2, D3, D4, D5, D6, D7, D8, and Dm. When valuing the IR Swap 270 on dates Ds, D2, D3, D4, D5, D6, D7, and D8, the 3-month delayed payment is taken into account.

The only times that the forward start interest rate swap 219 and a forward start IR Swap 270 with identical coupons and maturity dates will be the same is up and until the start date for the forward start IR Swap (from date Dt to Ds) and the settlement dates of the forward start interest rate swap (Ds, D2, D3, D4, D5, D6, D7, and D8). On the settlement dates the forward price will have converged to the spot price. Thus, if a party held the forward start interest rate swap to its maturity date, the forward start interest rate swap will synthetically replicate a forward start IR Swap with the same coupon and maturity date.

However, if a party wanted to exit their position at any time other than the forward start period and the settlement dates, they would be doing so at a forward price. A person knowledgeable in the art will understand how to value forward start interest rate swaps. There are a number of software platforms that allow for determination of the valuation of forward start interest rate swap, provided that there is accurate real time swap curve data. To determine the value of a forward start interest rate swap, the software programs simply need the trading date, start date (effective date), the maturity date, and the coupon rate of the IR Swap. The software can calculate the net present value of future cash flows on a daily basis to satisfy FAS 133.

The floating rate of the interest rate swaps of the present invention can be set to any floating-rate benchmark in any currency, such as for example commercial paper rates, T-Bill rates, Fed Funds, bank rates, repo rates or interbank rates (e.g., LIBOR; Tibor; Euribor), and can be in any currency (e.g., U.S. dollar, Euro, Yen, Swiss Franc, Pound Sterling, etc.). The interest rate swaps of the present invention can conform to the terms prescribed by the ISDA for the purposes of computing the daily fixing ISDA Benchmark Rates. For example, in the United States, the benchmark swap rate assumes a fixed semi-annual coupon (per 30/360 basis) against a 3-month LIBOR (per actual/360 basis) with payment in arrears.

The number of forward start futures that will make up the forward start interest rate swap of the present invention will be the tenor (number of months to the maturity date) of the forward start interest rate swap divided by the tenor of the floating rate date resets. In the United States, the floating rate resets are quarterly. A 10 year forward start interest rate swap of the present invention will thus be comprised of forty forward-start futures (tenor of 120 months divided by 3); a 2-year forward start interest rate swap of the present invention will be comprised of eight forward-start futures (tenor of 24 months divided by 3). If the floating date reset was semi-annually, the 10-year forward start interest rate swap of the present invention would be comprised of twenty forward start futures (tenor of 120 months divided by 6); a 2-year forward start interest rate swap of the present invention will be comprised of four forward start futures (tenor of 24 months divided by 6). The only difference between each of the forward start futures that are comprised in a forward start interest rate swap of the present invention will be the tenor (the number of months to maturity) of each of the forward start futures. Only one forward start futures per forward start interest rate swap will be trading at any given time. The tenor of each forward start interest rate swap will change with the passage of time. Each forward start interest rate swap of the present invention will be priced from the perspective of the receiver in an IR Swap.

The long in the interest rate swaps of the present invention is buying the position of the receiver (receiving fixed and paying floating) and the short is the payer (paying fixed and receiving floating).

On each Settlement Date, forward start interest rate swaps of the present invention will be cash settled to a distinguished swap rate such as for example the ISDA Benchmark Swap Rate. The ISDA Benchmark Swap Rates are posted at 11:30 a.m. (New York time) on a daily basis over the entire swap curve for maturities of 1, 2, 3, 4, 5, 6, 7, 8, 9, 10, and 30 years on the Reuters quote system (“ISDAFIX1”) and published in the Federal Reserve's H. 15 circular. The forward start interest rate swaps of the present invention that do not have a 1, 2, 3, 4, 5, 6, 7, 8, 9, 10, and 30 year maturities, will settle to the Benchmark Swap Curve using a standardized IR Swap valuation procedures and appropriate interpolation techniques (e.g., linear, exponential, cubic spline or exponential spline) using the ISDA Benchmark Swap Rates.

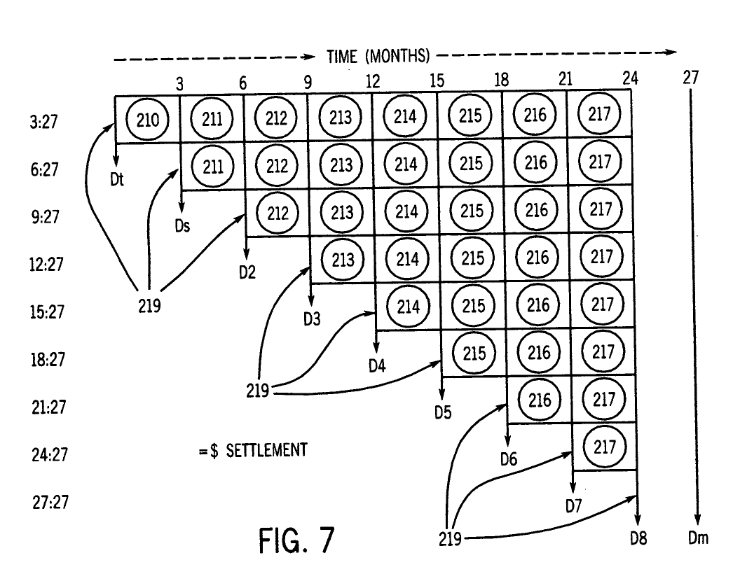

FIG. 7 is a diagram showing a 2-year forward start interest rate swap of the present invention. Forward start interest rate swap 219 reflects the forward start 2-year IR Swap. At date Dt (trading date) the forward start interest rate swap 219 is comprised of 8 forward start futures 210, 211, 212, 213, 214, 215, 216, and 217. Only one of these forward start futures will being listed and traded at any given time, and each of these forward start futures will settle and expire on dates Ds, D2, D3, D4, D5, D6, D7, and D8, respectively. All these forward start futures will have the same coupon rate and maturity date, but each will have a different settlement date, which will be reflective of a reset date in an IR Swap. For demonstration purposes, the coupon for the forward start interest rate swap is 5 percent.

On date Dt, the parties go long or short a forward start interest rate swap 219 which is pricing a forward start 2-year IR Swap with a five percent coupon to begin on date Ds and mature on date Dm. On date Ds, forward start future 210 settles to the price determined by the benchmark swap rate for a 2-year IR Swap on that date. After forward start futures 210 settles on date Ds, forward start future 210 subsequently expires and forward start future 211 is issued.

On date Ds, forward start future 211 is pricing a 3-month forward start 1-year-and-9-month IR Swap with a five percent coupon to begin on date D2 and mature on date Dm. On date D2, forward start futures 211 settles to the price determined by the benchmark swap rate for a 1-year-and-9-month IR Swap on that date. Forward start future 211 subsequently expires and forward start future 212 is issued.

On date D2, forward start future 212 is pricing a 3-month forward start 1-year-and-6-month IR Swap with a five percent coupon to start on date D3. On date D3, forward start future 212 settles to the price determined by the benchmark swap rate for a 1-year-and-6-month IR Swap. Forward start future 212 subsequently expires and forward start future 213 is issued.

On date D3, forward start future 213 is pricing a 3-month forward start 1-year-and-3-month IR Swap with a five percent coupon to start on date D4. On date D4, forward start future 213 settles to the price determined by the benchmark swap rate for a 1-year-and-3-month IR Swap. Forward start future 213 subsequently expires and forward start future 214 is issued.

On date D4, forward start swap 214 is pricing a 3-month forward start 1-year IR Swap with a five percent coupon to start on date D5. On date D5, forward start future 214 settles to the price determined by the benchmark swap rate for a 1-year IR Swap. Forward start future 214 subsequently expires and forward start future 215 is issued.

On date D5, forward start future 215 is pricing a 3-month forward start 9-month IR Swap with a five percent coupon to start on date D6. On date D6, forward start future 215 settles to the price determined by the benchmark swap rate for a 9-month IR Swap on that date. Forward start future 215 subsequently expires and forward start future 216 is issued.

On date D6, forward start future 216 is pricing a 3-month forward start 6-month IR Swap with a five percent coupon to start on date D7. On date D7, forward start future 216 settles to the price determined by the benchmark swap rate for a six-month IR Swap on that date. Forward start future 216 subsequently expires and forward start future 217 is issued.

On date D7, forward start future 217 is pricing a 3-month forward start 3-month IR Swap with a five percent coupon to start on date D8. On date D8, forward start future 217 settles to the price determined by the benchmark swap rate for a 3-month IR Swap on that date. Forward start future 217 expires and so does forward start interest rate swap 219, even though the forward start interest rate swap 219 has a maturity date of Dm, which is 3 months into the future. This is because in an U.S. LIBOR Swap, the floating-rate payments are determined on date D8 but are made 3 months in arrears on date Dm. On date DM an IR Swap is valued at zero. With the forward start interest rate swap 219, forward start future 217 will price that payment in arrears on date D8.

The spot interest rate swap of the present invention will be pricing an IR Swap for its coupon and maturity date.

If the coupon rate of the forward start interest rate swap of the present invention does not equal the benchmark swap rate for the identical tenor (maturity date), the forward start interest rate swap will be pricing an off-market IR Swap. As explained earlier, off-market IR Swaps in the OTC market are difficult to trade because parties find it difficult to get an acceptable price. The interest rate swaps of the present invention addresses this problem with the off-market IR Swaps by being electronically exchange traded. IR Swaps are quoted to par. The interest rate swaps of the present invention on price value.

No floating or fixed-rate payments are actually made under the interest rate swaps of the present invention; instead, the interest rate swaps price the discounted value of all future fixed-rate and floating-rate payments. The payments made are the changes in value which can be debited or credited to the holder's margin accounts for example on a daily basis. This determination of fair value fits in with FAS 133. The forward start interest rate swap can be valued daily. If the swap rate for a specific tenor is greater (less) than the coupon on the forward start interest rate swap, then the forward start interest rate swap will be priced at a discount (premium) to par.

In one embodiment, the interest rate swaps of the present invention can be traded on notional amounts in $100,000 dollars increments. For example, a trader could go long (short) $10,300,000 or $9,800,000. Each $100,000 represents an interest rate swap (future or spot), the number of which can be determined at the clearing agent. For the above trades, that would be 103 and 98 interest rate swaps of the present inventions, respectively. The interest rate swaps of the present invention can be listed on a price basis rather than on par value. The value can be defined from a number of processes that currently exist to determine the price for IR Swaps. These processes can be defined in detail to determine price at settlement date. Software exists that can derive the use data from the swap curve to calculate the fair value of the IR Swap. For example, Bloomberg provides data for the swap curve, and also provides its users with a number of calculators that can be used to quickly compute a no-arbitrage price for an IR Swap. Typing “SWPM” in the Bloomberg command line will create a screen that can be used to value IR Swaps. All that is required is for the user to input the coupon rate, the maturity date, and the effective date (settlement date). In another embodiment, the interest rate swaps of the present invention can be valued as a bond paying its coupon a given number times per year to its maturity date with the yield to maturity being the swap rate for the maturity of the interest rate swaps.

The interest rate swap price can be listed so that 100.000 points will be equivalent to the interest rate swap trading at par; that is where the coupon rate for the interest rate swap equals the swap rate for an equivalent maturity in the IR Swap market. If the interest rate swap has a notional value of $100,000, the value of the interest rate swap will be:
VDS=(N−(PDS+VIRS))*1,000

Where:
VDS=value of interest rate swap from receiver's perspective
N=notional value
PDS=par for interest rate swap (which will equal 100.000)
VIRS=value of the underlying IR Swap from receiver's perspective

For example, assume today is Sep. 30, 2007 and a Z 2005 4.50% Z 2010 (4.5% coupon expiring in December 2012) forward start interest rate swap is offered at 100.000. This would indicate that the underlying forward start IR Swap that the forward start interest rate swap is tracking (a forward start 5 year IR Swap with a 4.50 percent coupon) is at par; the underlying forward start IR Swap has zero value (the swap rate for a forward start 5 year IR Swap is also at 4.50%). Party A goes long the forward start interest rate swap and Party B goes short the forward start interest rate swap. Both parties passively hold their positions. One year later, the forward implied interest rates have risen and the forward start interest rate swap has a bid/offer of 98.873/98.877. The valuation for the underlying IR Swap is at the mid-point of the bid/offer would be 98.875. (The forward start interest rate swap is valued from the perspective of the party receiving fixed the long). The forward start interest rate swap has a negative value $1,125 ((100.000−98.875)*1,000). Party A (the long) is out-the-money $1,125 ($100.000−98.875)*1,000. The short will always have the inverse of the long. Party B (the short) is in-the-money by $1,125 ((($100.000−98.875)*1,000)*−1). Party A does not want to lose any more and decides to sell his position at 98.875 to Party C; Party A has taken a loss of $1,125 over the time he held the forward start interest rate swap. Party B believes that interest rates will increase and decides to sell to Party D at 98.875 and pockets the $1,125 gain over the time he held the forward start interest rate swap.

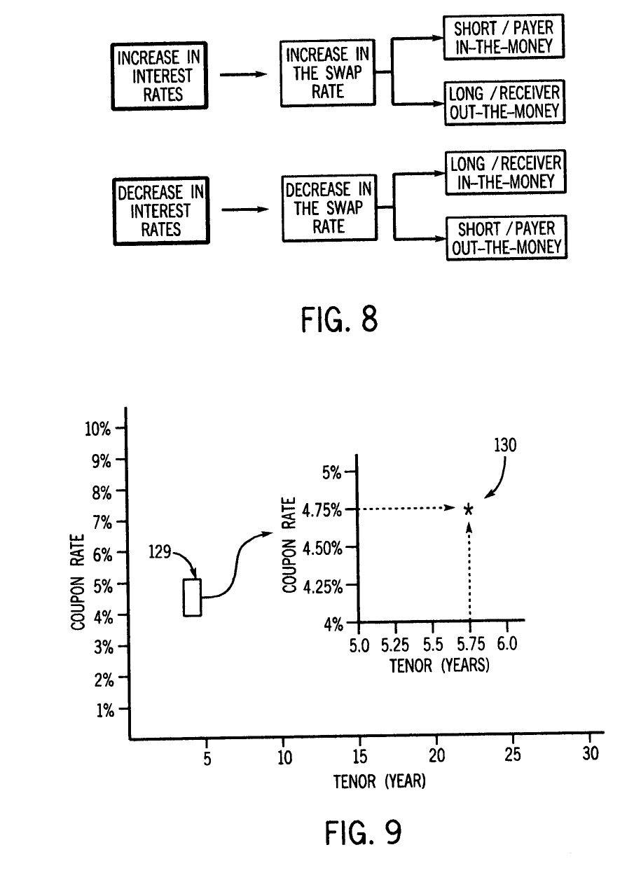

Parties C and D can only make/lose money if the value of the forward start interest rate swap changes from their execution price. If six months later, the forward start interest rate swap is listed at 98.475, the forward start interest rate swap has a negative value of $1,525 ((100.000−98.475)*1,000); however, both C and D did not buy the forward start interest rate swap at par and their accounts will only be credited or debited by the difference in current price and purchase price. Party C (the long) would have their margin account debited by $400 ((98.475−98.875)*1,000) and Party D (the short) would have their account credited by $400 (((98.475−98.875)*1,000)*−1). On the other hand, if the forward start interest rate swap was listed at 100.200, the value of the underlying IR Swap would be $2,000. Party C would have their margin account credited by $3,125 ((100.2−98.75)*1,000) and Party D would have their account debited by $3,125 ((100.2−98.75)*1,000)*−1). Provided that there is liquidity, the long and short will have the ability to exit their position. FIG. 8 shows how changes in interest rates affect the forward start interest rate swap of the present invention. The same applies to the spot interest rate swap of the present invention.

In another embodiment, the forward start interest rate swap of the present invention can have a tick size that follows conventions in the bond market and because the tenor of the forward start interest rate swap will lessen over time so will its tick size. Forward start interest rate swaps with maturities greater than 12 years can have a 1/32 tick ($31.25 per forward start interest rate swap). Forward start interest rate swaps with maturities ranging from 2 to 12 years can have a tick size of 1/64. Forward start interest rate swaps with maturities of less than 2 years can have a tick size of 1/128. For example, if the underlying IR Swap for a forward start interest rate swap has a maturity greater than 12 years and has a value of $98,475 the forward start interest rate swap can be quoted as 98:15, which would be equivalent to ($98,468).

Since the interest rate swaps of the present invention are a derivative of a forward start IR Swap, the interest rate swaps will have the same duration, modified duration, convexity, and basis point value (BPV/DV01) of a IR Swap (forward or spot) with identical coupon rate and maturity date.

The spot interest rate swap of the present invention will be standardized interest rate swaps defined by a coupon and maturity date and being priced in the spot market.

If the interest rate swaps of the present invention are to provide a secondary market for IR Swaps, there must be multiple interest rate swaps with a variety of maturity dates and coupon rates to offer multiple duration and convexity choices. This choice can be defined in accordance with the principles of the present invention by what is non-limitingly referred to herein as an interest rate swap array curve matrix.

In one embodiment of the interest rate swap array curve matrix of the present invention, the interest rate swap array curve matrix can consist of interest rate swaps with tenors that range from 3 months out to 30 years out in 3-month increments. The coupon rates can range from 0.25 percent to 8 percent (or whatever is the higher market rates) in 25 basis point (¼ percent) or 20 basis point (⅕) increments. FIG. 9 shows a sampling of the interest rate swap array curve matrix—a tenor and coupon rate for each grid point. The tenors (and maturity dates) are shown on the X axis and the coupon rate on the Y axis. At any specific X:Y point there will exist an interest rate swap. There will be multiple forward start interest rate swaps for each tenor. An interest rate swap with a coupon rate of 4.75% and maturity date 5.75 years is shown at 130. If today was Sep. 30, 2007, the forward start interest rate swap would represent a forward start 5 year-9-month IR Swap starting on the next settlement date, which would be December (Z) 2007. At each settlement, the forward start interest rate swaps pricing the 3-month forward start IR Swaps will expire and new forward start interest rate swaps pricing the 30-year forward start IR Swaps will be issued. The spot interest rate swap of the present invention will be valuing the spot price not the forward price.

Upon expiration, the subsequent forward start swaps for each forward start interest rate swap will be issued and they will have settlement date 3-months forward to the next IMM Settlement Date. The forward start interest rate swap with the shortest maturity (e.g., 3-month forward start future) will expire. Since at each IMM Settlement Date, each listed forward start future will have a 3 month less tenor, there will no longer be a forward start interest rate swap for the 30-year tenors; new 30-year tenor forward start interest rate swaps for each listed coupon rate will be issued.

In another embodiment of an interest rate swap array curve matrix in accordance with the principles of the present invention, the interest rate swap array curve matrix can initially consist of 11 interest rate swaps. The interest rate swaps will be tracking a 1, 2, 3, 4, 5, 6, 7, 8, 9, 10, and 30-year forward start IR Swaps. (The 30-year forward start interest rate swap may be added at a later date if a clearing agent desires to initially limit risk.) The initial coupon rate for each forward start interest rate swap will correlate with the then existing benchmark swap rates. Assuming that the interest rate swaps will be listed in 25 basis point increments, the coupon rate of the interest rate swaps will generally not exactly match the benchmark swap rates.

The coupon rate for each interest rate swap can be determined as follows: when the benchmark swap rates for a specific tenor is not exactly divisible by 0.25, the coupon rate for the interest rate swap can be adjusted to closely approximate the benchmark swap rate by taking the first coupon rate higher than the benchmark swap rate exactly divisible by 25 basis points and subtract the result from the benchmark swap rate. If the difference is less than 12.50 basis points, then the coupon rate used can be the first coupon rate in the interest rate swap array matrix greater than the benchmark swap rate; if the difference is greater than 12.50 basis points, then the first coupon rate in the interest rate swap array matrix less than the benchmark swap rate. For example, if the benchmark swap rates for a 4 year IR Swap is 3.89 percent, the coupon rates for the interest rate swap reflecting this tenor will be either 3.75 percent or 4.00 percent. Subtracting the benchmark swap rate from the first coupon rate of the interest rate swap array curve matrix above the benchmark swap rate (4.00 percent) is 11 basis points meaning that the coupon rate will be 4.00 percent.

After the first settlement on the IMM Settlement Date, the existing forward start interest rate swaps will be valuing a forward start IR Swaps with a tenor 3 months less than what they were before. A new set of 11 forward start interest rate swaps tracking forward start 1, 2, 3, 4, 5, 6, 7, 8, 9, 10, and 30-year (spot or forward start) IR Swaps can be issued. Again, they will be correlated to the benchmark swap rate. This will continue until there are sufficient interest rate swaps to fill the array curve matrix and the only new interest rate swaps that get issued are the 30-year interest rate swaps.

In another embodiment of the interest rate swap array curve matrix in accordance with the principles of the present invention, there can initially be 120 interest rate swaps. The interest rate swaps then will essentially be tracking a (spot or 3-month forward) IR Swap off the existing ISDA Benchmark Swap Curve 300 for every 3-month tenor out to 30 years. The coupon rate chosen for the forward start interest rate swaps will correlate the benchmark swap rates. For last two embodiments described, there could be two interest rate swaps listed for each tenor, reflecting coupon rates above and below the swap curve rate for that tenor.

There is a strong need to have a forward start interest rate swap that closely reflects the Benchmark Swap Curve. So, when there is a minimum of a 12.5 (or what another determine number) basis point move in the swap rate in either direction per tenor on the Benchmark Swap Curve, a new interest rate swap will be issued for that tenor with a coupon rate to reflect the new benchmark swap rate. For example, assume the benchmark swap rate for the 3-year tenor changes from 3.80 percent to 4.05 percent; a new 3-year interest rate swap will be immediately be issued reflecting a 4.00 percent coupon rate for that maturity date (tenor) (the coupon rate for the interest rate swap will be set to two decimal points and will be rounded up. Thus, the actual market Swap Rate of 3.825% will be rounded up to 3.83%).

There rollover risk (selling/buying expiring future and buying/selling new future) is addressed in the forward start interest rate swap of the present invention. When a party goes long or short a forward start interest rate swap, they hold the position in the forward start interest rate swap until its maturity date. Like an IR Swap, the party holding a forward start interest rate swap remains passive and is not exposed to roll over risk if they hold their position to maturity. A party, who has an open position on the IMM Settlement Date of a forward start interest rate swap, will have their position assigned into the newly issued forward start swap for that forward start interest rate swap. Thus, on the settlement date, each forward start swap can be settled to the ISDA Benchmark Rate or other valid data source. The positions of the long and short can be netted and then credited or debited depending on the changes in the value of the forward start interest rate swaps. The notional open interest after settlement will then be assigned to the newly issued forward start swap for the forward start interest rate swap.

The only time that a party has to take action with an interest rate swap of the present invention is when they do not want to hold a position in the interest rate swap. A party holding a position in an interest rate swap has to take action to unwind (offset/terminate) their position. For example, if a trader took a short position in forward start swap 210 and thirty days later he decides to terminate his position, he can offset his position by going long forward start swap 210. This offers an advantage over a traditional forward start IR Swap. In a forward start IR Swap once the IR Swap has started, it will not be easy to exit that position. A new IR Swap would have to be entered into to offset the recently executed IR Swap. With the interest rate swaps of the present invention, the party could exit the position at will, provided that there is a liquid market for the forward start interest rate swaps.

A clearing agent can daily net the trades for each forward start swap of a forward start interest rate swap into a single net exposure amount per client; the average price is determined for their long position and their short positions which are then matched and offset to reduce the number of transactions which in turn minimizes margin. Thus, if a trader on one day entered into 20 long positions and 15 short positions in a swap, those positions would be netted to 5 long positions at the average price. In the IR Swap Market, daily netting generally only occurs with dealers. Thus, a party that is unable to net would have 35 IR Swaps on their books and this would result in increased cost and the need for more management. If the IR Swaps require collateralization, the additional IR Swaps would impact the party's credit lines.

The interest rate swaps of the present invention can save users time and money. The interest rate swaps can be MTM daily by the clearing agent. The respective margin accounts of the parties can be debited and accredited to the amount that is the difference between the daily closing price (the mid-point of the bid and offer) and the price that the party acquired their position in the interest rate swap. Dealers will no longer have to manage collateral; instead, they would be required to satisfy the margin requirements of the clearing agent. The cost of the margin should be less that the cost providing and managing collateral. The difference between collateral and margin is that collateral is held in an escrow account until the IR Swap dates and it is then distributed to the accounts a two step process. With the interest rate swaps of the present invention, the margin accounts of the parties can be debited or credited daily.

Unlike an IR Swap, which has assignment restrictions and is not truly fungible, the interest rate swaps of the present invention are fungible because they are a multilateral agreement; the interest rate swap can be cleared by a centralized clearing agent. A party can unwind a position in an interest rate swap whenever they so desire (provided there is liquidity). For the forward start interest rate swap, this can also be done even if the position is unwound in different forward start swap of the same forward start interest rate swap.

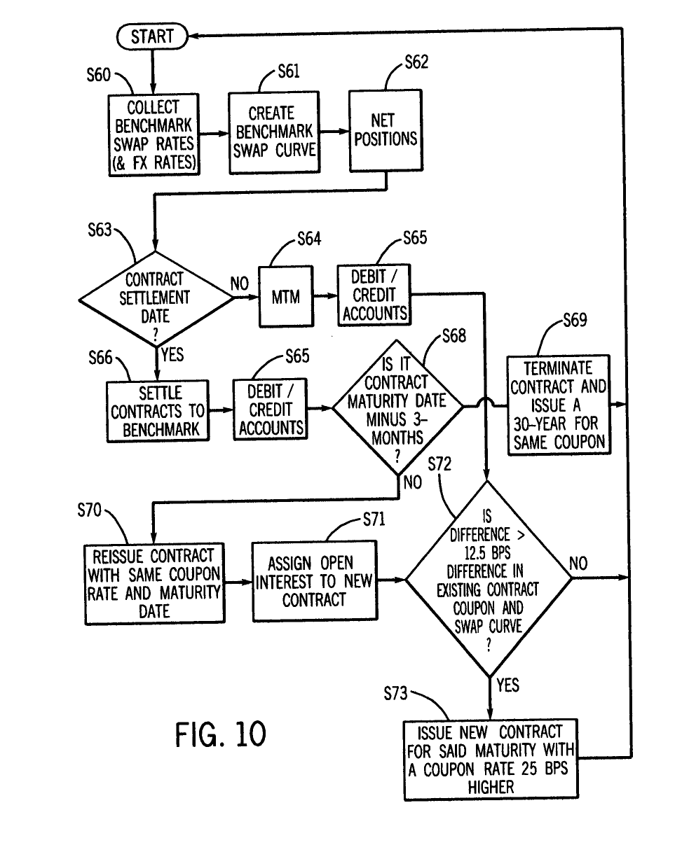

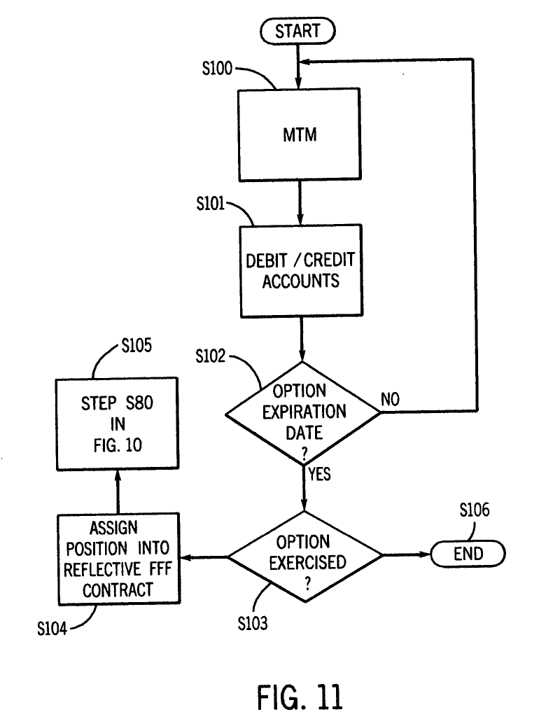

FIG. 10 is a flowchart that shows daily process for each forward start interest rate swap of the forward start interest rate swap array curve matrix of the present invention. In the first step in step S60, Benchmark Swap Curve data is collected from a data provider 12. In step S61, the Benchmark Swap Curve will be created so as to provide benchmark swap rates for all tenors. This data will be used in step S66 where the forward start interest rate swap settles on settlement dates and in step S72 to determine if a new forward start interest rate swap needs to be issued. In step 62 all open positions are netted. In step S63 a determination is made if it is a settlement date. If it is not, then in step S64 the netted open positions are MTM and in step 65 the trader's margin accounts are debited or credited. If it is a settlement date, then in step 66 the forward start interest rate swaps are settled to the benchmark swap rate and in step 65 the trader's margin accounts are debited or credited. In step 68, a determination is made if the settlement data that the forward start interest rate swap is 3 months from its maturity date. If it is, then in step S69 the forward start interest rate swap is terminated and a new 30-year forward start interest rate swap is issued for that coupon rate; if it is not, then in step S70 a new forward start swap for the forward start interest rate swap will be issued with the same coupon rate and maturity date and in step S71 the open interest in the forward start interest rate swap will be assigned into the new forward start swap. If the entire Swap Curve Array is not completed, then a determination is made if the benchmark swap rates for specific tenors have moved 12.5 basis. If they have, then in step S73 a new forward start interest rate swap is issued.

The only action that will taken for the spot interest rate swap of the present invention, is to MTM daily to the mid-point of the bid and offer spread for the interest rate swap, and then traders accounts will debited or credited accordingly. Because the interest rate swap will be MTM daily there will be no need for reset dates; the value of the forward start interest rate swap will be determined daily reflecting the appropriate cash flows and payment dates. When the spot interest rate swap reaches its maturity it expires.

FIG. 11 is a flowchart that shows the daily process for an interest rate swap option in accordance with the principles of the present invention. In step S101, the interest rate swap option is MTM and in step S102, the trader's margin accounts are credited or debited. In step S103 a determination is made if it is an options expiration date, which will be a settlement date. If it is not, then the process continues on the following day. If it is an options expiration date, then in step S104 a determination will be made if the interest rate swap option has been exercised. If it has not, then the interest rate swap option terminates. If it has, then the underlying forward start interest rate swap or the spot interest rate swap of the present invention the interest rate swap option is delivered and the process starts at step S60 in FIG. 10.

The uses for the interest rate swaps and interest rate swap option are virtually endless. As set forth in Table 1, below, the interest rate swap and interest rate swap option can be use for hedging, speculation, and for creating synthetic financial instruments:

TABLE 1
Uses for interest rate swap and interest rate swap option

| | |
|---|---|
| Short | Long |

Hedge an underlying Liability or Asset

| | |
|---|---|
| Issued a FRN (short an FRN) | Own an FRN (long an FRN) and warn to hedge |
| and wants to hedge against | aginst a decrease in interest rates |
| an increase in interest rates | |
| Own a bond (long a bond) | Issued a bond (snort a bond) and wants to hedge |
| and wants to hedge against | aginst a decrease in interest rates |
| an increase in interest rates | |
| Is a reciever in an OTC Swap | Is a payer in an OTC Swap (short the Swap) and want to hedge |
| (long the Swap) and wants to | aginst a decrease in interest rates |
| hedge against an increase in | |
| interest rates | |

Speculation

| | |
|---|---|
| Speculator who believes interest | Speculator who believes interest rates will decline |
| rates will increase | |
| Spread Trader | Spread Trader |

Lower Funding costs

| | |
|---|---|
| Creating a comparative advantage | Creating a comparative advantage by being able to raise |
| by being able to raise fixed rate | floating rate debt at a lower cost than would be available without |
| debt at a lower cost than would be | the LIBOR Finance Coupon Contract |
| available without the LIBOR Finance | |
| Coupon Contract | |

Shift Balance Sheet Exposure

| | |
|---|---|
| Shift floating rate liability | Shift fixed rate liability sensitivity to floating rate sensitivity |
| sensitivity to fixed rate sensitivity | |
| Shift fixed rate asset sensitivity | Shift floating rate asset sensitivity to fixed rate sensitivity |
| to floating rate sensitivity | |

Arbitrage

| | |
|---|---|
| Arbitrageur | Arbitrageur |

If held to its maturity date, the short in an interest rate swap of the present invention will have locked in a fixed rate payment and the long will have locked in receipt of a fixed income payment for the tenor of the interest rate swap. If the short has floating rate debt and is concerned about rising interest rates, the interest rate swap will provide a hedge. Likewise, an investor holding bonds that wants to hedge the bonds against a rise in interest rates will short the interest rate swap.

The longest-duration will provide the maximum price variation. If a portfolio manager expects a decline in interest rates, he may want to increase the average duration of his bond portfolio to experience maximum price volatility by going a long an interest rate swap of the present invention with a long duration. If he expects an increase in interest rates, he will reduce his average duration to minimize a price decline. At the same, the portfolio manager can also make a determination with regards to convexity. Since there will be, over time, multiple interest rate swaps for each maturity with different coupon rates, there will be a number of interest rate swaps that have durations which are relatively close. The portfolio manager may choose a slightly less duration if it has greater convexity. The greater the convexity, the more desirable will be as a lower capital loss will be entailed when interest rates rise.

The interest rate swaps of the present invention can also be used by banks, insurance companies, and pensions to adjust duration gap. If they have a negative duration gap, they will need to increase duration by going long an interest rate swap(s) with a longer duration. In contrast for a positive duration gap, companies will need to decrease duration by going short an interest rate swap(s) with a shorter duration.

The forward start interest rate swaps of the present invention can be used to hedge mortgage backed securities (MBS). MBS are callable securities and thus are negatively convex. When interest rates fall there is an increase in homeowner refinancing and this shortens duration. The opposite happens when interest rates rise. MBS hedgers will want to keep duration as constant as possible. So when interest rates decline they will go long the interest rate swap and when interest rates decline they will go short the interest rate swap.

The interest rate swap of the present invention can be used for hedging IR Swap books. Dealers, in general, do not match each and every IR Swap they enter into with an offsetting position; instead, swap dealers ‘warehouse’ new swaps concluded with clients, and the new swaps become part of his ‘book’. Hedging is then carried out on a portfolio basis using Eurodollar futures or forward-rate agreements (FRAs) in the front-end and government futures (bonds) from two years out. The objective is to manage IR Swaps book on a ‘delta neutral’ basis; that is, to eliminate interest-rate risk remaining once an off-setting position has been entered into. A dealer can use the interest rate swap of the present invention as a hedging tool for IR Swaps in addition to the Eurodollars and Treasuries futures, and can also use a forward start interest rate swap to create a synthetic IR Swap for clients.

The forward start interest rate swap of the present invention could be used for speculation purposes. Investors can enter into an interest rate swap to lock in favorable returns on their investments in anticipation of a change in interest rates. An investor who believes interest rates will rise (decline) can go short (long) an interest rate swap or a combination of interest rate swaps. A fund manager wanting to lock in a fix rate without borrowing long-term funds for a specified time can go short the appropriate interest rate swap.

The forward start interest rate swap of the present invention could be used for asset management through yield curve trades. For example, if a fund manager expects the yield curve to become steeper (interest rates for the longer tenor will increase at a faster rate than the short-term rates), a strategy could be to go long an interest rate swap on the short end and go short an interest rate swap on the long end of the curve. If he expects the yield curve to flatten (interest rates for the longer tenor will decrease at a faster rate than the short-term rates), he will go short an interest rate swap on the short end and go long an interest rate swap on the long end of the curve.

The forward start interest rate swap of the present invention can be used to manage floating asset exposure to changes in interest rates and reduce overall cost of borrowing. Traditionally, the yield curve is upward sloping, which means that floating rates at a specific point in time are less than fixed rates. This is because, to the lender, interest-rate risk is minimized with floating rates. Because of the reduced risk, many lenders prefer to lend at a floating rate. On the other hand, borrowers are exposed to interest-rate risk by borrowing at a floating rate. Borrowers would prefer to borrow at a fixed rate; however, borrowing fixed is more expensive. With the interest rate swaps, a lender can then lend a borrower finds at a floating rate (the lender's preferred structure). The borrower can then short an appropriate interest rate swap to lock in a fixed rate, and this fixed rate could be less than the fixed rate at which the borrower may have got from the lender. This is because the interest rate swap is based on the Benchmark Swap Curve (an AA credit rated curve). Thus, any borrower with less than an AA credit rating will find that they have been able to create a synthetic fixed-rate loan at a lower cost than what they could get from their lender. This will not affect the credit curve, because the interest rate swap can be margined on a daily basis. In other words, the ability to make margin payments can be monitored daily.

The forward start interest rate swap of the present invention can be complemented by customized trading facilities to support basis trading between the forward start interest rate swap, the spot interest swap and IR Swaps. Trading facilities can be established by one of ordinary skill in the art to trade the interest rate swap of the present invention.

The interest rate swaps of the present invention and Swap Curve Matrix of the present invention can be used for IR Swaps in other markets and currencies. The interest rate swaps could be used for other global IR Swaps: for example, US $ (annual actual basis against 3 month LIBOR), Yen (semi-annual actual/365 basis against 6 month LIBOR); Euro (annual bond 30/360 against 6 month Euribor); Swiss (annual bond 30/360 against 6 month LIBOR; and Pound Sterling (semi-annual actual/365 basis against 6 month LIBOR). Traders interested in structuring interest rates trades in difference currencies will have the ability to go one long (short) an interest rate swap in one currency and short (long) an interest rate swap in another currency. This is essentially a currency swap.

Options can be traded on the interest rate swaps of the present invention. A pay-fixed interest rate swap option and a receive-fixed interest rate swap option can be quoted for any forward start swap of interest rate swap in the swap, regardless if it is currently trading. An interest rate swap option can be used to manage interest-rate risk through a yield curve trade. If the yield curve steepens, the value of a pay-fixed interest rate swap option will increase with higher interest rates and the value of a received-fixed interest rate swap options will decline. The opposite will happen if rates decline.

For example, assume it is Sep. 26, 2007. An investor believes that the 5 year yield will be lower than implied yield one year from now. She could execute a forward start swap that will start on December 2008, but wishes to limit her potential loss. She could instead buy a receive-fixed interest rate swap option for Z2008 5.50 Z2013. This will give her the right to receive fixed under a 5 year swap to begin in fifteen months. The strike rate is the rate at which the interest rate swap (swap) will take effect. If rates fall below the strike rate, she will choose to enter into the interest rate swap, receiving fixed at the strike level. This deal could then be closed out at a profit or allowed to run as an interest rate swap. Should 5 year rates be higher than the strike at maturity, she will choose not to receive fixed under the interest rate swap option as she can do so in the market at a more attractive rate.

In another aspect in accordance with the principles of the present invention, an application program interface can be provided for users of the interest rate swap of the present invention and interest rate swap option of the present invention. The application program interface of the present invention can be a web-based platform specifically designed for the present invention. The application program interface of the present invention can be tied to the electronic trading platform's (exchange) trading screen or be located on an independent web site.

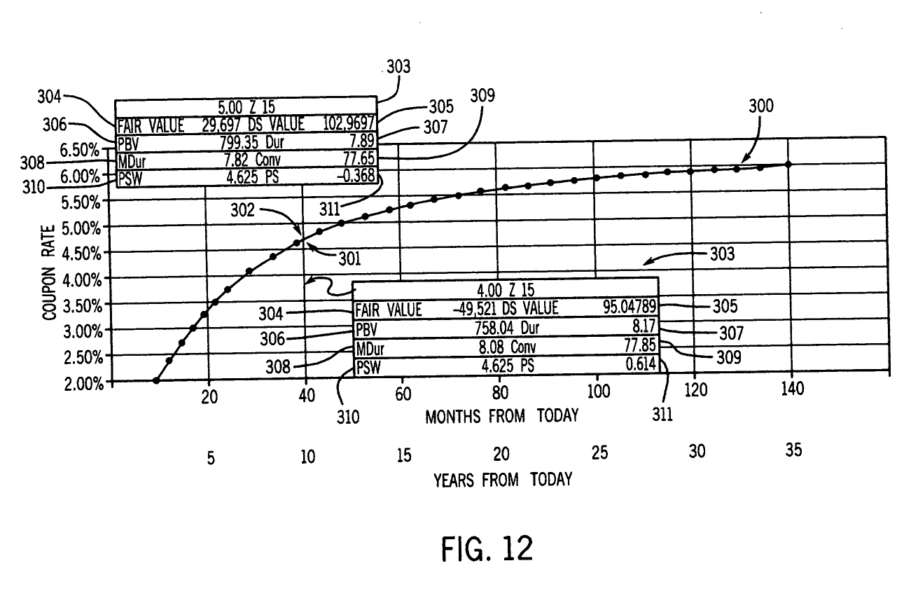

The application program interface of the present invention can provide important data for interest rate swaps of the present invention and interest rate swap options of the present invention. The application program interface of the present invention can display data graphically. Referring to FIG. 12, a screen can show the benchmark swap curve 300. If the application program interface is on an independent web site, it will have access to the real time Benchmark Swap Curve data from a data provider 12. If it is used on a trading screen it will rely on the mid-point of the bid and offer spread for the swap curve. The X axis can represent coupon rates and the Y axis time to maturity in years and/or months. Data for existing interest rate swaps can be retrieved by clicking/moving a computer mouse to any point on the screen. The grid points for where there is an interest rate swap can be marked with a dot. If a user clicked at the 5 percent coupon with a ten year tenor, a box can pop up on the screen 301 which would provide the name 303 of the forward start interest rate swap (which in turn will provide the maturity date for the interest rate swap) 303, the benchmark fair value if on an independent web site (or the value derived from the midpoint of the bid/offer prices on an exchange) 304, the list price for the interest rate swap 305, the point basis value (PBV) 306, duration (Dur) 307, modified duration (Mdur) 308, convexity (Conv) 309, par swap rate (PSR) 310, and par spread (PS) 311.

When the name of an interest rate swap of the present invention is selected in the application program interface, a cash flow can be displayed. Referring to Table 2, an example is seen.

TABLE 2
Cash Flow Table

| | fixed | fixed | floating | floating | | | total cashflow | present | |
|---|---|---|---|---|---|---|---|---|---|
| cash flow | interest | principal | interest | principal | net interest | net principal | (principal + | value total | discount |
| date | payment | payment | payment | payment | payment | payment | interest) | cashflow | factor |
| 15-Dec-2004 | 0.00 | 0.00 | 4,326.91 | 0.00 | 4,326.91 | 0.00 | 4,326.91 | 4,305.45 | 0.99504027 |
| 15-Mar-2005 | −17,597.22 | 0.00 | 4,748.71 | 0.00 | −12,848.52 | 0.00 | −12,848.52 | −12,740.22 | 0.99157105 |
| 15-Jun-2005 | 0.00 | 0.00 | 4,858.67 | 0.00 | 4,858.67 | 0.00 | 4,858.67 | 4,800.39 | 0.98800567 |
| 15-Sep-2005 | −17,888.89 | 0.00 | 5,244.90 | 0.00 | −12,643.98 | 0.00 | −12,643.98 | −12,442.62 | 0.98407438 |
| 15-Dec-2005 | 0.00 | 0.00 | 6,465.13 | 0.00 | 6,465.13 | 0.00 | 6,465.13 | 6,329.16 | 0.97896893 |
| 15-Mar-2006 | −17,597.22 | 0.00 | 8,212.00 | 0.00 | −9,385.22 | 0.00 | −9,385.22 | −9,124.32 | 0.97220047 |
| 15-Jun-2006 | 0.00 | 0.00 | 9,808.33 | 0.00 | 9,808.33 | 0.00 | 9,808.33 | 9,454.74 | 0.96395067 |
| 15-Sep-2006 | −17,888.89 | 0.00 | 10,121.41 | 0.00 | −7,767.48 | 0.00 | −7,767.48 | −7,421.63 | 0.95547426 |
| 15-Dec-2006 | 0.00 | 0.00 | 10,296.38 | 0.00 | 10,296.38 | 0.00 | 10,296.38 | 9,749.72 | 0.94690817 |
| 15-Mar-2007 | −17,597.22 | 0.00 | 11,207.52 | 0.00 | −6,389.70 | 0.00 | −6,389.70 | −5,990.81 | 0.93757228 |
| 15-Jun-2007 | 0.00 | 0.00 | 12,402.28 | 0.00 | 12,402.26 | 0.00 | 12,402.28 | 11,499.78 | 0.92723154 |
| 17-Sep-2007 | −18,083.33 | 0.00 | 12,909.68 | 0.00 | −5,173.65 | 0.00 | −5,173.65 | −4,742.02 | 0.91657008 |
| 17-Dec-2007 | 0.00 | 0.00 | 12,719.94 | 0.00 | 12,719.94 | 0.00 | 12,719.94 | 11,526.51 | 0.90617630 |
| 17-Mar-2008 | −17,694.44 | 0.00 | 13,437.71 | 0.00 | −4,256.73 | 0.00 | −4,256.73 | −3,810.90 | 0.89526506 |

A new window thus opens that provides detailed information on the respective cash flows of the underlying IR Swap that the interest rate swap is tracking based on the existing swap curve. On the screen will be a box titled ‘duration’. A double clink on the duration value will open a new window which provides a listing of a plurality of durations and convexities for other interest rate swaps in close proximity to the duration of the interest rate swap. Double clicking on any of those durations will result in returning to the original screen showing the Benchmark Swap Curve and window that will pop up for the interest rate swap with that specific duration. Likewise, double clicking on modified duration will open a new window which will provide a listing a plurality of modified durations and convexities for other interest rate swaps in close proximity to the duration of the interest rate swap. Double clicking on any of those modified durations will result in going back to the original window showing the Benchmark Swap Graph, and a window that will pop up for the interest rate swap with that duration. In another embodiment of the present invention, a user can specify a desired duration by inserting that number in a box that is on the screen. The application program interface of the present invention will then open up a new window which will provide a listing of interest rate swap with durations that closely match that number.

It should be understood that various changes and modifications preferred in to the embodiment described herein would be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. A method for making vanilla interest rate swap more fungible by creating a synthetic interest rate swap comprising:
selecting a consecutive series of futures that value a forward start interest rate swap to start on a settlement date; and
selecting a term of the futures that replicates the floating-rate payment terms for the interest rate swap that is being synthetically replicated.

2. The method of making a vanilla interest rate swap more fungible of claim 1 further including exchange and electronic trading.

3. The method of making a vanilla interest rate swap more fungible of claim 1 further including clearing through a centralized clearing agent.

4. The method of making a vanilla interest rate swap more fungible of claim 1 further including the consecutive series of futures that value a forward start interest rate swap starting on an upcoming International Monetary Market (IMM) settlement date.

5. The method of making a vanilla interest rate swap more fungible of claim 1 further including tracking an interest rate swap that conforms to the terms prescribed by the ISDA in each market.

6. The method of making a vanilla interest rate swap more fungible of claim 1 further comprising establishing a secondary market for interest rate swaps.

7. The method of making a vanilla interest rate swap more fungible of claim 1 further comprising a clearing agent automatically netting trades on a daily basis.

8. The method of making a vanilla interest rate swap more fungible of claim 1 further comprising marking-to-market the synthetically replicated vanilla interest rate swap daily.

9. The method of making a vanilla interest rate swap more fungible of claim 1 further comprising defining the synthetically replicated vanilla interest rate swap by maturity date, effective date, and coupon.

10. The method making a vanilla interest rate swap more fungible of claim 1 further comprising the number of futures that make up the synthetically replicated vanilla interest rate swap being the tenor of the synthetically replicated vanilla interest rate swap divided by the tenor of floating rate date resets.

11. The method making a vanilla interest rate swap more fungible of claim 10 further comprising cash settling to a distinguished swap rate.

12. The method making a vanilla interest rate swap more fungible of claim 10 further comprising cash settling to the ISDA Benchmark Swap Rate.

13. The method making a vanilla interest rate swap more fungible of claim 1 further comprising valuing the synthetically replicated vanilla interest rate swap in accordance with:
VDS=(N−(PDS+VIRS))*K
Where:
VDS=value of synthetically replicated vanilla interest rate swap from receiver's perspective;
N=notional value;
PDS=par for FFF;
VIRS=value of the underlying IR Swap from receiver's perspective, and
K=a notional constant.

14. The method making a vanilla interest rate swap more fungible of claim 1 further comprising trading an option off of the synthetically replicated vanilla interest rate swap.

15. The method making a vanilla interest rate swap more fungible of claim 14 further comprising trading a pay-fixed synthetically replicated vanilla interest rate swap option.

16. The method making a vanilla interest rate swap more fungible of claim 14 further comprising trading a receive-fixed synthetically replicated vanilla interest rate swap option.

17. A method for making a spot vanilla interest rate swap more fungible comprising creating a synthetic interest rate swap and selecting spot interest rate swaps that value an existing interest rate swap.

18. The method of making a spot vanilla interest rate swap more fungible of claim 17 further including exchange and electronic trading.

19. The method of making a spot vanilla interest rate swap more fungible of claim 17 further including clearing through a centralized clearing agent.

20. The method of making a spot vanilla interest rate swap more fungible of claim 17 further including tracking an interest rate swap that conforms to the terms prescribed by the ISDA in each market.

21. The method of making a spot vanilla interest rate swap more fungible of claim 17 further comprising establishing a secondary market for interest rate swaps.

22. The method of making a spot vanilla interest rate swap more fungible of claim 1 further comprising a clearing agent automatically netting trades on a daily basis.

23. The method of making a spot vanilla interest rate swap more fungible of claim 17 further comprising marking-to-market the synthetically replicated vanilla interest rate swap daily.

24. The method of making a spot vanilla interest rate swap more fungible of claim 17 further comprising defining the synthetically replicated vanilla interest rate swap by maturity date and coupon.

25. The method making a spot vanilla interest rate swap more fungible of claim 24 further comprising cash settling to a distinguished swap rate.

26. The method making a spot vanilla interest rate swap more fungible of claim 24 further comprising cash settling to the ISDA Benchmark Swap Rate.

27. The method making a spot vanilla interest rate swap more fungible of claim 17 further comprising valuing the synthetically replicated vanilla interest rate swap in accordance with:
VDS=(N−(PDS+VIRS))*K
Where:
VDS=value of synthetically replicated vanilla interest rate swap from receiver's perspective;
N=notional value;
PDS=par for FFF;
VIRS=value of the underlying IR Swap from receiver's perspective, and
K=a notional constant.

28. The method making a spot vanilla interest rate swap more fungible of claim 17 further comprising trading an option off of the synthetically replicated vanilla interest rate swap.

29. An array curve matrix of synthetic interest rate swaps comprising a plurality of synthetically replicated vanilla interest rate swaps having tenors that range from relatively short-term to relatively long-term in a periodic increment.

30. An array curve matrix of synthetic interest rate swaps of claim 29 further wherein the future synthetic interest rate swap comprises a consecutive series of futures that value a forward start interest rate swap to start on a settlement date and the spot synthetic interest rate swap values an existing interest rate swap.

31. The array curve matrix of synthetic interest rate swaps of claim 29 further wherein at settlement, synthetically replicated vanilla interest rate swaps pricing the relatively short-term forward start interest rate swaps will expire and new synthetically replicated vanilla interest rate swaps pricing the relatively long-term forward start interest rate swaps will be issued.

32. The array curve matrix of synthetic interest rate swaps of claim 29 further including tenors that range from 3 months out to 30 years out in 3-month increments.

33. The array curve matrix of synthetic interest rate swaps of claim 32 further wherein at each settlement, synthetic futures interest rate swap pricing the 3-month forward start interest rate swaps will expire and new synthetically futures interest rate swaps pricing the 30-year forward start interest rate swaps will be issued.

34. The array curve matrix of synthetic interest rate swaps of claim 29 further wherein the plurality of synthetically replicated vanilla interest rate swaps comprise a plurality of synthetically replicated spot vanilla interest rate swaps.

35. The array curve matrix of synthetic interest rate swaps of claim 29 further wherein the plurality of synthetically replicated vanilla interest rate swaps comprise a plurality of synthetically replicated vanilla interest rate swap futures.

36. An application program interface comprising a plurality of synthetic vanilla interest rate swaps.

37. The application program interface of claim 36 further comprising a plurality of synthetic vanilla interest rate swaps options.

38. The application program interface of claim 36 further wherein the application program interface comprises a web-based platform.

39. The application program interface of claim 36 further wherein the application program interface comprises a graphical display of data related to the synthetic vanilla interest rate swaps.

40. The application program interface of claim 39 further comprising graphically displaying swap curve coupon rates and time to maturity.

41. The application program interface of claim 39 further comprising graphically displaying synthetic vanilla interest rate swaps.

42. The application program interface of claim 36 further wherein the application program interface comprises a graphical display of data related to the synthetic vanilla interest rate swaps.

43. The application program interface of claim 36 further comprising a plurality of synthetic spot vanilla interest rate swaps.

44. The application program interface of claim 36 further comprising a plurality of synthetic vanilla interest rate swap futures.
